(19) United States
(12) Patent Application Publication
(10) Pub. No.: US 2021/0065581 A1
(43) Pub. Date: Mar. 4, 2021

(54) NUMBER PUZZLES

(71) Applicant: Celina Taylor, Elkridge, MD (US)

(72) Inventor: Celina Taylor, Elkridge, MD (US)

(21) Appl. No.: 16/554,121

(22) Filed: Aug. 28, 2019

(51) Int. Cl. G09B 19/02; A63F 9/10

(52) U.S. Cl. CPC G09B 19/02; A63F 9/10

(57) ABSTRACT

Described herein is are apparatuses for facilitating learning through the use of one or more senses. One apparatus includes a puzzle having a plurality of pieces that form a numeral. The puzzle includes a shape that matches the numeral, and a number of the plurality of pieces equal to the numeral.

### FIELD

This disclosure relates generally to puzzles, and more particularly to number puzzles.

### BACKGROUND

Number puzzles may be used as an educational tool. As an educational tool, number puzzles may be used with developing children, including developing children that have learning challenges. Some number puzzles may be challenging and too difficult for a person with learning challenges, while other number puzzles may be too simple and may not advance learning.

### SUMMARY

The subject matter of the present application has been developed in response to the present state of the art, and in particular, in response to shortcomings of conventional number puzzles used for education. For example, conventional number puzzles do not provide an adequate learning tool to help advance the learning of a student.

Accordingly, the subject matter of the present application has been developed to provide apparatuses that overcome at least some of the above-discussed shortcomings of prior art techniques. More particularly, in some embodiments, described herein are apparatuses that include one or more number puzzles to facilitate learning advancement.

One apparatus includes a puzzle having a plurality of pieces that form a numeral. The puzzle includes a shape that matches the numeral, and a number of the plurality of pieces equal to the numeral.

In one embodiment, a weight of each piece of the plurality of pieces is substantially the same. In some embodiments, a weight of the puzzle has a weight of one piece of the plurality of pieces times the numeral. In various embodiments, each piece of the plurality of pieces includes an indicator corresponding to the numeral.

In certain embodiments, each piece of the plurality of pieces includes an indicator indicating the numeral. In one embodiment, each piece of the plurality of pieces includes an indicator indicating a number one. In some embodiments, a height of the puzzle is directly proportional to the numeral.

In various embodiments, the height of the puzzle is determined based on the following formula: the height=x*(the numeral−1)+y. In certain embodiments, at least two pieces of the plurality of pieces have the same shape. In one embodiment, pieces of the plurality of pieces that do not have the same shape cannot be improperly connected together.

In one embodiment, an apparatus includes: a first puzzle having a first plurality of pieces that form a first numeral, wherein the first puzzle includes: a first shape that matches the first numeral; and the first plurality of pieces equal to the first numeral; and a second puzzle having a second plurality of pieces that form a second numeral, wherein the second puzzle includes: a second shape that matches the second numeral; and the second plurality of pieces equal to the second numeral, wherein the first numeral and the second numeral are different.

In certain embodiments, a first weight of each piece of the first plurality of pieces is substantially the same as a second weight of each piece of the second plurality of pieces. In some embodiments, a first weight of the first puzzle has a weight of one piece of the first plurality of pieces times the first numeral, and a second weight of the second puzzle has the weight times the second numeral. In various embodiments, each piece of the first plurality of pieces includes a first indicator corresponding to the first numeral, and each piece of the second plurality of pieces includes a second indicator corresponding to the second numeral.

In one embodiment, each piece of the first plurality of pieces includes a first indicator indicating the first numeral, and each piece of the second plurality of pieces includes a second indicator indicating the second numeral. In certain embodiments, each piece of the first plurality of pieces and the second plurality of pieces includes an indicator indicating a number one. In some embodiments, a first height of the first puzzle is directly proportional to the first numeral, and a second height of the second puzzle is directly proportional to the second numeral.

In various embodiments, the first height of the first puzzle is determined based on the following formula: the first height=x*(the first numeral−1)+y, and the second height of the second puzzle is determined based on the following formula: the second height=x*(the second numeral−1)+y. In one embodiment, each piece of the first plurality of pieces has a different shape from each piece of the second plurality of pieces.

In one embodiment, an apparatus includes: a first puzzle having one piece that forms the number one in a first shape that matches the number one; a second puzzle having two pieces that form the number two in a second shape that matches the number two; a third puzzle having three pieces that form the number three in a third shape that matches the number three; a fourth puzzle having four pieces that form the number four in a fourth shape that matches the number four; a fifth puzzle having five pieces that form the number five in a fifth shape that matches the number five; a sixth puzzle having six pieces that form the number six in a sixth shape that matches the number six; a seventh puzzle having seven pieces that form the number seven in a seventh shape that matches the number seven; an eighth puzzle having eight pieces that form the number eight in an eighth shape that matches the number eight; and a ninth puzzle having nine pieces that form the number nine in a ninth shape that matches the number nine.

In certain embodiments, a first weight of the first puzzle is substantially the same as a second weight of each piece of the second puzzle, a third weight of each piece of the third puzzle, a fourth weight of each piece of the fourth puzzle, a fifth weight of each piece of the fifth puzzle, a sixth weight of each piece of the sixth puzzle, a seventh weight of each piece of the seventh puzzle, an eight weight of each piece of the eight puzzle, and a ninth weight of each piece of the ninth puzzle.

In some embodiments, each piece of the first puzzle includes a first indicator corresponding to the number one, each piece of the second puzzle includes a second indicator corresponding to the number two, each piece of the third puzzle includes a third indicator corresponding to the number three, each piece of the fourth puzzle includes a fourth indicator corresponding to the number four, each piece of the fifth puzzle includes a fifth indicator corresponding to the number five, each piece of the sixth puzzle includes a sixth indicator corresponding to the number six, each piece of the seventh puzzle includes a seventh indicator corresponding to the number seven, each piece of the eighth puzzle includes an eighth indicator corresponding to the number eight, and each piece of the ninth puzzle includes a ninth indicator corresponding to the number nine.

In various embodiments, a first height of the first puzzle is determined based on the following formula: the first height=x*(the number one−1)+y, a second height of the second puzzle is determined based on the following formula: the second height=x*(the number two−1)+y, a third height of the third puzzle is determined based on the following formula: the third height=x*(the number three−1)+y, a fourth height of the fourth puzzle is determined based on the following formula: the fourth height=x*(the number four−1)+y, a fifth height of the fifth puzzle is determined based on the following formula: the fifth height=x*(the number five−1)+y, a sixth height of the sixth puzzle is determined based on the following formula: the sixth height=x*(the number six−1)+y, a seventh height of the seventh puzzle is determined based on the following formula: the seventh height=x*(the number seven−1)+y, an eighth height of the eighth puzzle is determined based on the following formula: the eighth height=x*(the number eight−1)+y, and a ninth height of the ninth puzzle is determined based on the following formula: the ninth height=x*(the number nine−1)+y.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter, they are not therefore to be considered to be limiting of its scope. The subject matter will be described and explained with additional specificity and detail through the use of the drawings, in which:

FIG. 1 is a top view of one embodiment of a set of number puzzles that are assembled;

FIG. 2 is an exploded view of one embodiment of a set of number puzzles;

FIG. 3 is a top view of one embodiment of a first number puzzle that forms the number one;

FIG. 4 is an exploded top view of one embodiment of a second number puzzle that forms the number two;

FIG. 5 is an exploded perspective view of one embodiment of a second number puzzle that forms the number two;

FIG. 6 is an exploded top view of one embodiment of a third number puzzle that forms the number three;

FIG. 7 is an exploded perspective view of one embodiment of a third number puzzle that forms the number three;

FIG. 8 is an exploded top view of one embodiment of a fourth number puzzle that forms the number four;

FIG. 9 is an exploded perspective view of one embodiment of a fourth number puzzle that forms the number four;

FIG. 10 is an exploded top view of one embodiment of a fifth number puzzle that forms the number five;

FIG. 11 is an exploded perspective view of one embodiment of a fifth number puzzle that forms the number five;

FIG. 12 is an exploded top view of one embodiment of a sixth number puzzle that forms the number six;

FIG. 13 is an exploded perspective view of one embodiment of a sixth number puzzle that forms the number six;

FIG. 14 is an exploded top view of one embodiment of a seventh number puzzle that forms the number seven;

FIG. 15 is an exploded perspective view of one embodiment of a seventh number puzzle that forms the number seven;

FIG. 16 is an exploded top view of one embodiment of an eighth number puzzle that forms the number eight;

FIG. 17 is an exploded perspective view of one embodiment of an eighth number puzzle that forms the number eight;

FIG. 18 is an exploded top view of one embodiment of a ninth number puzzle that forms the number nine; and

FIG. 19 is an exploded perspective view of one embodiment of a ninth number puzzle that forms the number nine.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

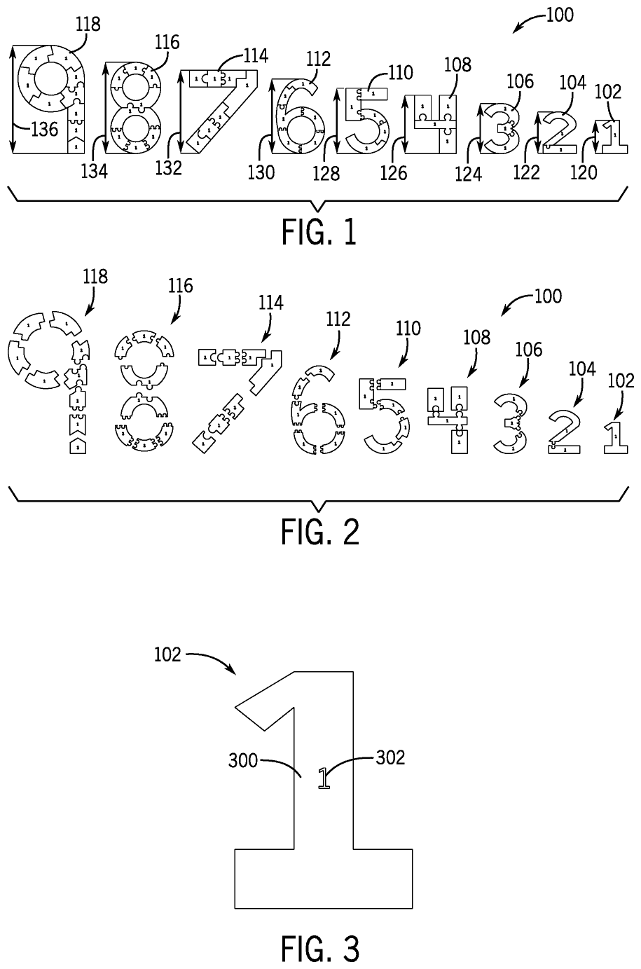

FIG. 1 is a top view of one embodiment of a set of number puzzles 100 that are assembled. The set of number puzzles 100 includes a first number puzzle 102 that forms the number one, a second number puzzle 104 that forms the number two, a third number puzzle 106 that forms the number three, a fourth number puzzle 108 that forms the number four, a fifth number puzzle 110 that forms the number five, a sixth number puzzle 112 that forms the number six, a seventh number puzzle 114 that forms the number seven, an eighth number puzzle 116 that forms the number eight, and a ninth number puzzle 118 that forms the number nine. As illustrated, each of the number puzzles includes a number of pieces that matches (e.g., is equal to) the number (e.g., the numeral). For example, the first number puzzle 102 includes one piece, the second number puzzle 104 includes two pieces, the third number puzzle 106 includes three pieces, and so forth. Furthermore, each of the number puzzles has a shape that matches the number. For example, the first number puzzle 102 is shaped like the number 1, the second number puzzle 104 is shaped like the number 2, the third number puzzle 106 is shaped like the number 3, the fourth number puzzle 108 is shaped like the number 4, and so forth. As may be appreciated, while the illustrated numbers are written using Arabic numerals, the numerals may be written using any type of written numerals, such as the following numerals: East Asian, Chinese, Japanese, Korean, Greek, Hebrew, Devanagari, Gujarati, Gurmukhi, Tibetan, Bengali, Kannada, Odia, Malayalam, Tamil, Telugu, Khmer, Thai, Lao, Burmese, Persian, Urdu, Mongolian, Roman, and so forth.

In FIG. 1, the first number puzzle 102 has a first height 120, the second number puzzle 104 has a second height 122, the third number puzzle 106 has a third height 124, the fourth number puzzle 108 has a fourth height 126, the fifth number puzzle 110 has a fifth height 128, the sixth number puzzle 112 has a sixth height 130, the seventh number puzzle 114 has a seventh height 132, the eighth number puzzle 116 has an eighth height 134, and the ninth number puzzle 118 has a ninth height 136. In certain embodiments, the height of each number puzzle may be different to facilitate determining the different numbers based on their height. As may be appreciated, while the height is described in relation to FIG. 1, the term height may be substituted for height and/or width (e.g., size). For example, the width may be different for each number puzzle to facilitate determining the different numbers based on the width. As another example, both the width and the height of each number puzzle may be different from each other to facilitate determining the different numbers based on the width and/or the height.

In one embodiment, the first height 120 is less than the second height 122, the second height 122 is less than the third height 124, the third height 124 is less than the fourth height 126, the fourth height 126 is less than the fifth height 128, the fifth height 128 is less than the sixth height 130, the sixth height 130 is less than the seventh height 132, the seventh height 132 is less than the eighth height 134, and the eight height 134 is less than the ninth height 136. Accordingly, as the numbers increase, the height also increases. Therefore, the first height 120 of the first number puzzle 102 is the smallest height and the ninth height 136 of the ninth number puzzle 118 is the largest height. The difference in height may facilitate helping an individual understand how the aggregate number system works (e.g., how each number is proportionately larger than a closest lower number). For example, to help an individual visually and/or tactilely know that 1 is less than 9, and to know that 7 is more than 3.

In certain embodiments, a height of each number puzzle is directly proportional to the numeral that the puzzle is for. In some embodiments, this may be a linear change, while in other embodiments, the change may be exponential. In various embodiments, the height of the number puzzle may be determined using the following formula: height=x*(the numeral−1)+y, where y is the height of the first number puzzle 102 that is in the shape of the number one, the numeral is the number corresponding to the number puzzle for which the height is being determined, and x is a difference in height between two adjacent number puzzles. For example, if the height difference between two adjacent number puzzles is 0.5 inches (x), and the height of the first number puzzle is 3.0 inches (y), then the formula for the height of each number puzzle is: 0.5*(the numeral−1)+3.0. Using this formula, the first height 120 would be 3.0 inches, the second height 122 would be 3.5 inches, the third height 124 would be 4.0 inches, the fourth height 126 would be 4.5 inches, the fifth height 128 would be 5.0 inches, the sixth height 130 would be 5.5 inches, the seventh height 132 would be 6.0 inches, the eight height 134 would be 6.5 inches, and the ninth height 134 would be 7.0 inches.

In one embodiment, the width of the number puzzle may be determined using the following formula: width=x*(the numeral−1)+y, where y is the width of the first number puzzle 102 that is in the shape of the number one, the numeral is the number corresponding to the number puzzle for which the width is being determined, and x is a difference in width between two adjacent number puzzles.

In certain embodiments, a color of each number puzzle (e.g., paint applied to each number puzzle) may be different. For example, the first number puzzle 102 may be yellow, the second number puzzle 104 may be red, the third number puzzle 106 may be green, and so forth. The color of each number puzzle may be any suitable color. By having each number puzzle be a different color, this may facilitate sorting puzzle pieces for a number puzzle from other number puzzles. Furthermore, this may facilitate reducing confusion for individuals putting the number puzzles together. In some embodiments, the color of the top of each number puzzle is different, while the bottom of each number puzzle is the same color (e.g., black), thereby facilitating distinguishing between the top and the bottom of puzzle pieces. In various embodiments, a border edge around the top of each number puzzle may be the same for each piece (e.g., black) to facilitate showing the edges of the number puzzle and/or to facilitate assembly of each number puzzle.

In certain embodiments, each number puzzle may have a different texture than other number puzzles to facilitate tactilely distinguishing each number puzzle (e.g., to aid individuals with sensory deprivation and/or visual impairments). The different textures may include one or more of the following (or different variations of the following): soft, bumpy, textile patterns, smooth, rough, and so forth to bring attention to the individuality of each number puzzle. In one embodiment, the first number puzzle 102 may be the smoothest number puzzle, while the ninth number puzzle 118 may be the roughest number puzzle. In some embodiments, the texture may only be applied to the top of each number puzzle. In various embodiments, a smell may be applied to each number puzzle so that each number puzzle has a different smell. In certain embodiments, a flavor may be applied to each number puzzle so that each number puzzle has a different taste.

As may be appreciated, the different features of the number puzzles may help individuals with disabilities and/or young individuals (e.g., pre-K children) to understand the concept of number aggregation though different sensory exploration (e.g., visual, touch, smell, taste, etc.).

FIG. 2 is an exploded view of one embodiment of the set of number puzzles 100. This figure shows how each number puzzle includes a number of pieces equal to the number corresponding to the number puzzle. For example, the first number puzzle 102 has 1 puzzle piece, the second number puzzle 104 has 2 puzzle pieces, the third number puzzle 106 has 3 puzzle pieces, the fourth number puzzle 108 has 4 puzzle pieces, the fifth number puzzle 110 has 5 puzzle pieces, the sixth number puzzle 112 has 6 puzzle pieces, the seventh number puzzle 114 has 7 puzzle pieces, the eighth number puzzle 116 has 8 puzzle pieces, and the ninth number puzzle 118 has 9 puzzle pieces.

FIG. 3 is a top view of one embodiment of the first number puzzle 102 that forms the number one. The first number puzzle 102 has a single puzzle piece 300 so that the number of puzzle pieces (e.g., 1) equals the shape of the puzzle (e.g., shape of the number 1). The single puzzle piece 300 has a unitary indicator 302 that indicates the number 1. As will be described herein, each puzzle piece includes the unitary indicator 302 indicating the number 1 to indicate a numeric value corresponding to the puzzle piece as it relates to the numeral. The indicator 302 may be made on the single puzzle piece 300 in any suitable manner. For example, the indicator 302 may be an opening in the shape of the number 1, the indicator 302 may extend out of the single puzzle piece 300, or the indicator 302 may be otherwise visible on the single puzzle piece 300 (e.g., painted on, printed on, applied to, etc.).

In some embodiments, the single puzzle piece 300 has a weight that matches individual pieces of other puzzles. Accordingly, the weight of each puzzle piece among the set of number puzzles 100 is the same. Moreover, a weight of a numeric number puzzle may be the weight of one piece (“P_{w}”) of the number puzzle times the numeral (e.g., 1). Therefore, if P_{w} is 100 grams, the weight of the first number puzzle 102 is 100 grams times 1=100 grams.

The single puzzle piece 300 may be formed from any suitable material. For example, the single puzzle piece 300 may be formed from one or more of wood, plastic, metal, and so forth.

In certain embodiments, a shape of the single puzzle piece 300 may be different from a shape of puzzle pieces for other number puzzles so that the single puzzle piece 300 will not fit together with puzzle pieces for other number puzzles.

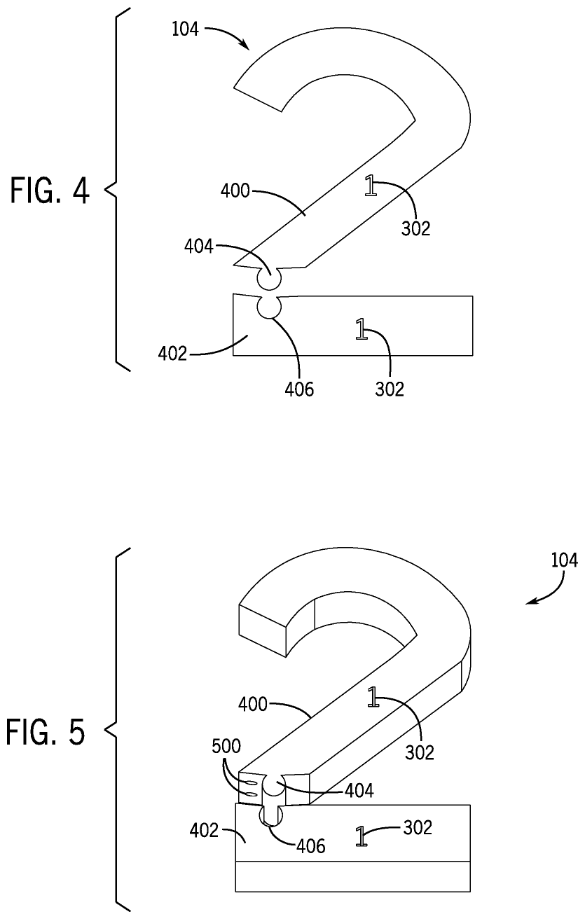

FIG. 4 is an exploded top view of one embodiment of the second number puzzle 104 that forms the number two. The second number puzzle 104 has a first puzzle piece 400 and a second puzzle piece 402 so that the number of puzzle pieces (e.g., 2) equals the shape of the puzzle (e.g., shape of the number 2). The first puzzle piece 400 and the second puzzle piece 402 each has the unitary indicator 302 that indicates the number 1. Thus, by adding the unitary indicator 302 of the first puzzle piece 400 (e.g., 1) to the unitary indicator 302 of the second puzzle piece 402 (e.g., 1) together, they equal the number (e.g., 2) corresponding to the second number puzzle 104. This may facilitate an individual understanding the concept that a sum of the parts equals the whole number and/or may facilitate teaching fractions.

In some embodiments, a weight of the first puzzle piece 400 matches a weight of the second puzzle piece 402 and a weight of individual pieces of other puzzles (e.g., the single puzzle piece 300). Accordingly, the weight of each puzzle piece among the set of number puzzles 100 is the same. Moreover, a weight of a numeric number puzzle may be the weight of one piece (“P_{w}”) of the number puzzle times the numeral (e.g., 2). Therefore, if P_{w} is 100 grams, the weight of the second number puzzle 104 is 100 grams times 2=200 grams.

The first puzzle piece 400 and the second puzzle piece 402 may be formed from any suitable material. For example, the first puzzle piece 400 and the second puzzle piece 402 may be formed from one or more of wood, plastic, metal, and so forth.

As illustrated, the first puzzle piece 400 has a first connector 404 that connects with a second connector 406 of the second puzzle piece 402 to connect the puzzle pieces together. In some embodiments, one or more magnets and/or Velcro may be positioned at the first connector 404 and the second connector 406 to facilitate connection of the first puzzle piece 400 to the second puzzle piece 402 and/or to secure the first puzzle piece 400 to the second puzzle piece 402.

In certain embodiments, a shape of the first puzzle piece 400 and the second puzzle piece 402 may be different from a shape of puzzle pieces for other number puzzles so that the first puzzle piece 400 and the second puzzle piece 402 will not fit together with puzzle pieces for other number puzzles. Moreover, it should be noted that for one number puzzle, pieces within the puzzle may have the same shape and may be interchangeable. Furthermore, if pieces within the puzzle do not have the same shape, the connectors on the puzzle pieces may be different so that pieces may not be improperly connected together.

FIG. 5 is an exploded perspective view of one embodiment of the second number puzzle 104 that forms the number two. Each of the first puzzle piece 400 and the second puzzle piece 402 has a numeral indicator 500 that indicates that the first puzzle piece 400 and the second puzzle piece 402 belong to the second number puzzle 104. The numeral indicator 500 may be any indication that the puzzle pieces are part of the second number puzzle 104, such as dots (e.g., two dots as illustrated), the numeral itself, or some other indication. In certain embodiments, the numeral indicator 500 may be discernable visually (e.g., painted on, printed on, etc.) and/or tactilely (e.g., an indention, a protrusion, etc.). The number indicator 500 may facilitate an individual knowing what number they are making by providing a hint about a shape and/or number of pieces for the puzzle that is being assembled.

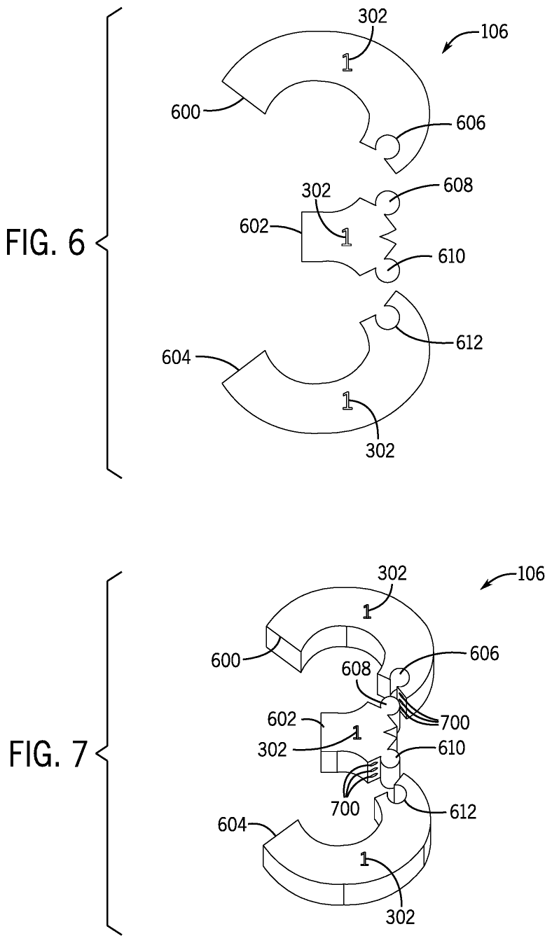

FIG. 6 is an exploded top view of one embodiment of the third number puzzle 106 that forms the number three. The third number puzzle 106 has a first puzzle piece 600, a second puzzle piece 602, and a third puzzle piece 604 so that the number of puzzle pieces (e.g., 3) equals the shape of the puzzle (e.g., shape of the number 3). The first puzzle piece 600, the second puzzle piece 602, and the third puzzle piece 604 each have the unitary indicator 302 that indicates the number 1. Thus, by adding the unitary indicators 302 of the first puzzle piece 600 (e.g., 1), the second puzzle piece 602 (e.g., 1), and the third puzzle piece 604 (e.g., 1), they equal the number (e.g., 3) corresponding to the third number puzzle 106. This may facilitate an individual understanding the concept that a sum of the parts equals the whole number and/or may facilitate teaching fractions.

In some embodiments, a weight of the first puzzle piece 600 matches (e.g., equals) a weight of the second puzzle piece 602, the weight of the second puzzle piece 602 matches a weight of the third puzzle piece 604, and each of the first, second, and third puzzle pieces 600, 602, 604 matches a weight of individual pieces of other puzzles (e.g., the single puzzle piece 300). Accordingly, the weight of each puzzle piece among the set of number puzzles 100 is the same. Moreover, a weight of a numeric number puzzle may be the weight of one piece (“P_{w}”) of the number puzzle times the numeral (e.g., 3). Therefore, if P_{w} is 100 grams, the weight of the third number puzzle 106 is 100 grams times 3=300 grams.

The first puzzle piece 600, the second puzzle piece 602, and the third puzzle piece 604 may be formed from any suitable material. For example, the first puzzle piece 600, the second puzzle piece 602, and the third puzzle piece 604 may be formed from one or more of wood, plastic, metal, and so forth.

As illustrated, the first puzzle piece 600 has a first connector 606 that connects with a second connector 608 of the second puzzle piece 602 to connect the puzzle pieces together. Moreover, the second puzzle piece 602 has a third connector 610 that connects with a fourth connector 612 of the third puzzle piece 604. In some embodiments, one or more magnets and/or Velcro be positioned at the first connector 606, the second connector 608, the third connector 610, and the fourth connector 612 to facilitate connection of the first puzzle piece 600, the second puzzle piece 602, and the third puzzle piece 604, and/or to secure the first puzzle piece 600, the second puzzle piece 602, and the third puzzle piece 604 together.

In certain embodiments, a shape of the first puzzle piece 600, the second puzzle piece 602, and the third puzzle piece 604 may be different from a shape of puzzle pieces for other number puzzles so that the first puzzle piece 600, the second puzzle piece 602, and the third puzzle piece 604 will not fit together with puzzle pieces for other number puzzles. Moreover, it should be noted that for one number puzzle, pieces within the puzzle may have the same shape and may be interchangeable. For example, the first puzzle piece 600 and the third puzzle piece 604 are the same shape, the same height, and/or the same width, and may be interchangeable. Accordingly, the first connector 606 and the fourth connector 612 may have the same shape, and the second connector 608 and the third connector 610 may have the same shape. Furthermore, if pieces within the puzzle do not have the same shape, the connectors on the puzzle pieces may be different so that pieces may not be improperly connected together.

FIG. 7 is an exploded perspective view of one embodiment of the third number puzzle 106 that forms the number three. Each of the first puzzle piece 600, the second puzzle piece 602, and the third puzzle piece 604 has a numeral indicator 700 that indicates that the first puzzle piece 600, the second puzzle piece 602, and the third puzzle piece 604 belong to the third number puzzle 106. The numeral indicator 700 may be any indication that the puzzle pieces are part of the third number puzzle 106, such as dots (e.g., three dots as illustrated), the numeral itself, or some other indication. In certain embodiments, the numeral indicator 700 may be discernable visually (e.g., painted on, printed on, etc.) and/or tactilely (e.g., an indention, a protrusion, etc.). The number indicator 700 may facilitate an individual knowing what number they are making by providing a hint about a shape and/or number of pieces for the puzzle that is being assembled.

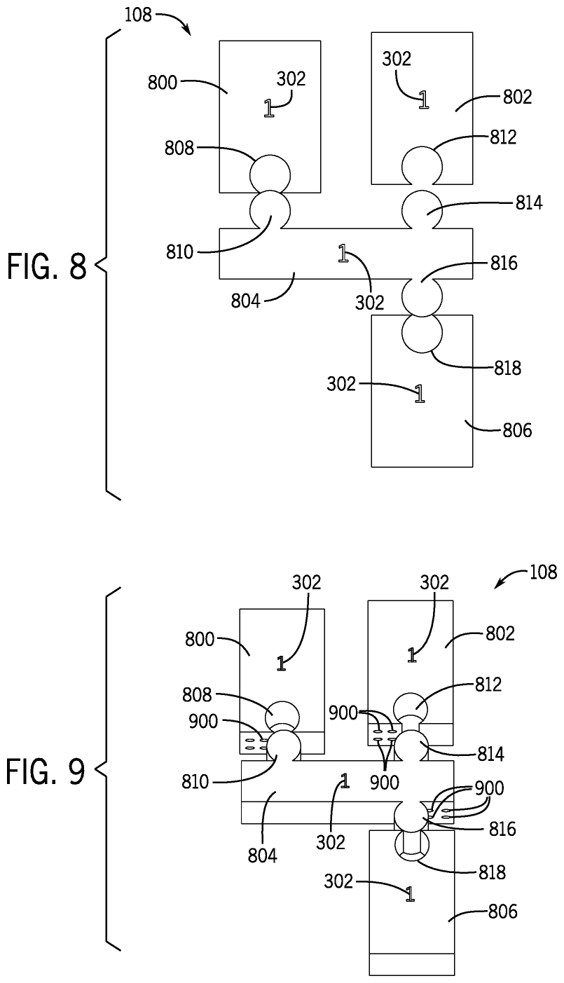

FIG. 8 is an exploded top view of one embodiment of the fourth number puzzle 108 that forms the number four. The fourth number puzzle 108 has a first puzzle piece 800, a second puzzle piece 802, a third puzzle piece 804, and a fourth puzzle piece 806 so that the number of puzzle pieces (e.g., 4) equals the shape of the puzzle (e.g., shape of the number 4). The first puzzle piece 800, the second puzzle piece 802, the third puzzle piece 804, and the fourth puzzle piece 806 each have the unitary indicator 302 that indicates the number 1. Thus, by adding the unitary indicators 302 of the first puzzle piece 800 (e.g., 1), the second puzzle piece 802 (e.g., 1), the third puzzle piece 804 (e.g., 1), and the fourth puzzle piece 806 (e.g., 1), they equal the number (e.g., 4) corresponding to the fourth number puzzle 108. This may facilitate an individual understanding the concept that a sum of the parts equals the whole number and/or may facilitate teaching fractions.

In some embodiments, a weight of the first puzzle piece 800 matches (e.g., equals) a weight of the second puzzle piece 802, the weight of the second puzzle piece 802 matches a weight of the third puzzle piece 804, the weight of the third puzzle piece 804 matches a weight of the fourth puzzle piece 806, and each of the first, second, third, and fourth puzzle pieces 800, 802, 804, 806 matches a weight of individual pieces of other puzzles (e.g., the single puzzle piece 300). Accordingly, the weight of each puzzle piece among the set of number puzzles 100 is the same. Moreover, a weight of a numeric number puzzle may be the weight of one piece (“P_{w}”) of the number puzzle times the numeral (e.g., 4). Therefore, if P_{w} is 100 grams, the weight of the fourth number puzzle 108 is 100 grams times 4=400 grams.

The first puzzle piece 800, the second puzzle piece 802, the third puzzle piece 804, and the fourth puzzle piece 806 may be formed from any suitable material. For example, the first puzzle piece 800, the second puzzle piece 802, the third puzzle piece 804, and the fourth puzzle piece 806 may be formed from one or more of wood, plastic, metal, and so forth.

As illustrated, the first puzzle piece 800 has a first connector 808 that connects with a second connector 810 of the third puzzle piece 804 to connect the puzzle pieces together. Moreover, the second puzzle piece 802 has a third connector 812 that connects with a fourth connector 814 of the third puzzle piece 804. Furthermore, the third puzzle piece 804 has a fifth connector 816 that connects with a sixth connector 818 of the fourth puzzle piece 806. In some embodiments, one or more magnets and/or Velcro be positioned at the first connector 808, the second connector 810, the third connector 812, the fourth connector 814, the fifth connector 816, and the sixth connector 818 to facilitate connection of the first puzzle piece 800, the second puzzle piece 802, the third puzzle piece 804, and the fourth puzzle piece 806, and/or to secure the first puzzle piece 800, the second puzzle piece 802, the third puzzle piece 804, and the fourth puzzle piece 806 together.

In certain embodiments, a shape of the first puzzle piece 800, the second puzzle piece 802, the third puzzle piece 804, and the fourth puzzle piece 806 may be different from a shape of puzzle pieces for other number puzzles so that the first puzzle piece 800, the second puzzle piece 802, the third puzzle piece 804, and the fourth puzzle piece 806 will not fit together with puzzle pieces for other number puzzles. Moreover, it should be noted that for one number puzzle, pieces within the puzzle may have the same shape and may be interchangeable. For example, the first puzzle piece 800, the second puzzle piece 802, and the fourth puzzle piece 806 are the same shape, the same height, and/or the same width, and may be interchangeable. Accordingly, the first connector 808, the third connector 812, and the sixth connector 818 may have the same shape, and the second connector 810, the fourth connector 814, and the fifth connector 816 may have the same shape. Furthermore, if pieces within the puzzle do not have the same shape, the connectors on the puzzle pieces may be different so that pieces may not be improperly connected together.

FIG. 9 is an exploded perspective view of one embodiment of the fourth number puzzle 108 that forms the number four. Each of the first puzzle piece 800, the second puzzle piece 802, the third puzzle piece 804, and the fourth puzzle piece 806 has a numeral indicator 900 that indicates that the first puzzle piece 800, the second puzzle piece 802, the third puzzle piece 804, and the fourth puzzle piece 806 belong to the fourth number puzzle 108. The numeral indicator 900 may be any indication that the puzzle pieces are part of the fourth number puzzle 108, such as dots (e.g., four dots as illustrated), the numeral itself, or some other indication. In certain embodiments, the numeral indicator 900 may be discernable visually (e.g., painted on, printed on, etc.) and/or tactilely (e.g., an indention, a protrusion, etc.). The number indicator 900 may facilitate an individual knowing what number they are making by providing a hint about a shape and/or number of pieces for the puzzle that is being assembled.

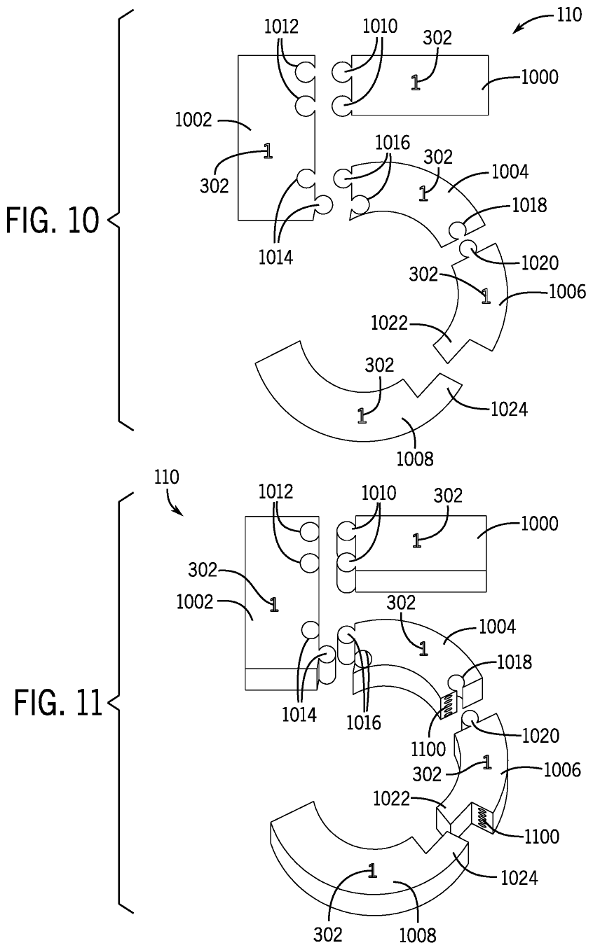

FIG. 10 is an exploded top view of one embodiment of the fifth number puzzle 110 that forms the number five. The fifth number puzzle 110 has a first puzzle piece 1000, a second puzzle piece 1002, a third puzzle piece 1004, a fourth puzzle piece 1006, and a fifth puzzle piece 1008 so that the number of puzzle pieces (e.g., 5) equals the shape of the puzzle (e.g., shape of the number 5). The first puzzle piece 1000, the second puzzle piece 1002, the third puzzle piece 1004, the fourth puzzle piece 1006, and the fifth puzzle piece 1008 each have the unitary indicator 302 that indicates the number 1. Thus, by adding the unitary indicators 302 of the first puzzle piece 1000 (e.g., 1), the second puzzle piece 1002 (e.g., 1), the third puzzle piece 1004 (e.g., 1), the fourth puzzle piece 1006 (e.g., 1), and the fifth puzzle piece 1008 (e.g., 1), they equal the number (e.g., 5) corresponding to the fifth number puzzle 110. This may facilitate an individual understanding the concept that a sum of the parts equals the whole number and/or may facilitate teaching fractions.

In some embodiments, a weight of each of the first puzzle piece 1000, the second puzzle piece 1002, the third puzzle piece 1004, the fourth puzzle piece 1006, and the fifth puzzle piece 1008 is substantially the same, and each of the first puzzle piece 1000, the second puzzle piece 1002, the third puzzle piece 1004, the fourth puzzle piece 1006, and the fifth puzzle piece 1008 matches a weight of individual pieces of other puzzles (e.g., the single puzzle piece 300). Accordingly, the weight of each puzzle piece among the set of number puzzles 100 is the same (e.g., approximately the same, within 1%, 5%, or 10% of one another). Moreover, a weight of a numeric number puzzle may be the weight of one piece (“P_{w}”) of the number puzzle times the numeral (e.g., 5). Therefore, if P_{w} is 100 grams, the weight of the fifth number puzzle 110 is 100 grams times 5=500 grams.

The first puzzle piece 1000, the second puzzle piece 1002, the third puzzle piece 1004, the fourth puzzle piece 1006, and the fifth puzzle piece 1008 may be formed from any suitable material. For example, the first puzzle piece 1000, the second puzzle piece 1002, the third puzzle piece 1004, the fourth puzzle piece 1006, and the fifth puzzle piece 1008 may be formed from one or more of wood, plastic, metal, and so forth.

As illustrated, the first puzzle piece 1000 has a first connector 1010 that connects with a second connector 1012 of the second puzzle piece 1002 to connect the puzzle pieces together. Moreover, the second puzzle piece 1002 has a third connector 1014 that connects with a fourth connector 1016 of the third puzzle piece 1004. Furthermore, the third puzzle piece 1004 has a fifth connector 1018 that connects with a sixth connector 1020 of the fourth puzzle piece 1006. In addition, the fourth puzzle piece 1006 has a seventh connector 1022 that connects with an eighth connector 1024 of the fifth puzzle piece 1008. In some embodiments, one or more magnets and/or Velcro be positioned at the first connector 1010, the second connector 1012, the third connector 1014, the fourth connector 1016, the fifth connector 1018, the sixth connector 1020, the seventh connector 1022, and the eighth connector 1024 to facilitate connection of the first puzzle piece 1000, the second puzzle piece 1002, the third puzzle piece 1004, the fourth puzzle piece 1006, and the fifth puzzle piece 1008, and/or to secure the first puzzle piece 1000, the second puzzle piece 1002, the third puzzle piece 1004, the fourth puzzle piece 1006, and the fifth puzzle piece 1008 together.

In certain embodiments, a shape of the first puzzle piece 1000, the second puzzle piece 1002, the third puzzle piece 1004, the fourth puzzle piece 1006, and the fifth puzzle piece 1008 may be different from a shape of puzzle pieces for other number puzzles so that first puzzle piece 1000, the second puzzle piece 1002, the third puzzle piece 1004, the fourth puzzle piece 1006, and the fifth puzzle piece 1008 will not fit together with puzzle pieces for other number puzzles. Moreover, it should be noted that for one number puzzle, pieces within the puzzle may have the same shape and may be interchangeable. For example, in some embodiments, but not illustrated, the third puzzle piece 1004 and the fourth puzzle piece 1006 may be the same shape, the same height, and/or the same width, and may be interchangeable. Furthermore, if pieces within the puzzle do not have the same shape, the connectors on the puzzle pieces may be different so that pieces may not be improperly connected together.

FIG. 11 is an exploded perspective view of one embodiment of the fifth number puzzle 110 that forms the number five. Each of the first puzzle piece 1000, the second puzzle piece 1002, the third puzzle piece 1004, the fourth puzzle piece 1006, and the fifth puzzle piece 1008 has a numeral indicator 1100 that indicates that the first puzzle piece 1000, the second puzzle piece 1002, the third puzzle piece 1004, the fourth puzzle piece 1006, and the fifth puzzle piece 1008 belong to the fifth number puzzle 110. The numeral indicator 1100 may be any indication that the puzzle pieces are part of the fifth number puzzle 110, such as dots (e.g., five dots as illustrated), the numeral itself, or some other indication. In certain embodiments, the numeral indicator 1100 may be discernable visually (e.g., painted on, printed on, etc.) and/or tactilely (e.g., an indention, a protrusion, etc.). The number indicator 1100 may facilitate an individual knowing what number they are making by providing a hint about a shape and/or number of pieces for the puzzle that is being assembled.

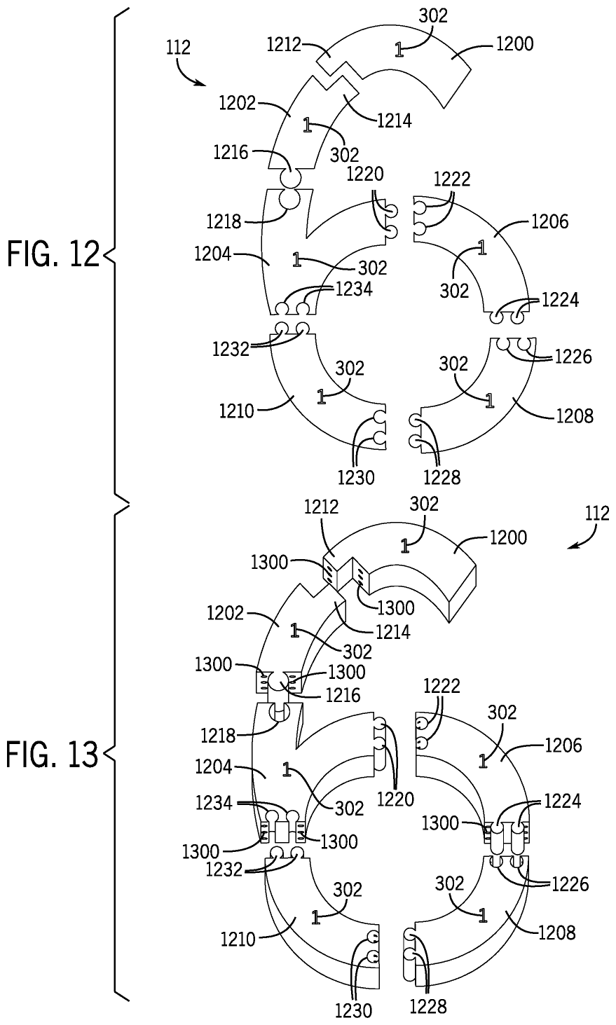

FIG. 12 is an exploded top view of one embodiment of the sixth number puzzle 112 that forms the number six. The sixth number puzzle 112 has a first puzzle piece 1200, a second puzzle piece 1202, a third puzzle piece 1204, a fourth puzzle piece 1206, a fifth puzzle piece 1208, and a sixth puzzle piece 1210 so that the number of puzzle pieces (e.g., 6) equals the shape of the puzzle (e.g., shape of the number 6). The first puzzle piece 1200, the second puzzle piece 1202, the third puzzle piece 1204, the fourth puzzle piece 1206, the fifth puzzle piece 1208, and the sixth puzzle piece 1210 each have the unitary indicator 302 that indicates the number 1. Thus, by adding the unitary indicators 302 of the first puzzle piece 1200 (e.g., 1), the second puzzle piece 1202 (e.g., 1), the third puzzle piece 1204 (e.g., 1), the fourth puzzle piece 1206 (e.g., 1), the fifth puzzle piece 1208 (e.g., 1), and the sixth puzzle piece 1210 (e.g., 1), they equal the number (e.g., 6) corresponding to the sixth number puzzle 112. This may facilitate an individual understanding the concept that a sum of the parts equals the whole number and/or may facilitate teaching fractions.

In some embodiments, a weight of each of the first puzzle piece 1200, the second puzzle piece 1202, the third puzzle piece 1204, the fourth puzzle piece 1206, the fifth puzzle piece 1208, and the sixth puzzle piece 1210 is substantially the same, and each of the first puzzle piece 1200, the second puzzle piece 1202, the third puzzle piece 1204, the fourth puzzle piece 1206, the fifth puzzle piece 1208, and the sixth puzzle piece 1210 matches a weight of individual pieces of other puzzles (e.g., the single puzzle piece 300). Accordingly, the weight of each puzzle piece among the set of number puzzles 100 is the same (e.g., approximately the same, within 1%, 5%, or 10% of one another). Moreover, a weight of a numeric number puzzle may be the weight of one piece (“P_{w}”) of the number puzzle times the numeral (e.g., 6). Therefore, if P_{w} is 100 grams, the weight of the sixth number puzzle 112 is 100 grams times 6=600 grams.

The first puzzle piece 1200, the second puzzle piece 1202, the third puzzle piece 1204, the fourth puzzle piece 1206, the fifth puzzle piece 1208, and the sixth puzzle piece 1210 may be formed from any suitable material. For example, the first puzzle piece 1200, the second puzzle piece 1202, the third puzzle piece 1204, the fourth puzzle piece 1206, the fifth puzzle piece 1208, and the sixth puzzle piece 1210 may be formed from one or more of wood, plastic, metal, and so forth.

As illustrated, the first puzzle piece 1200 has a first connector 1212 that connects with a second connector 1214 of the second puzzle piece 1202 to connect the puzzle pieces together. Moreover, the second puzzle piece 1202 has a third connector 1216 that connects with a fourth connector 1218 of the third puzzle piece 1204. Furthermore, the third puzzle piece 1204 has a fifth connector 1220 that connects with a sixth connector 1222 of the fourth puzzle piece 1206. In addition, the fourth puzzle piece 1206 has a seventh connector 1224 that connects with an eighth connector 1226 of the fifth puzzle piece 1208. The fifth puzzle piece 1208 has a ninth connector 1228 that connects with a tenth connector 1230 of the sixth puzzle piece 1210. Moreover, the sixth puzzle piece 1210 has an eleventh connector 1232 that connects with a twelfth connector 1234 of the third puzzle piece 1204. In some embodiments, one or more magnets and/or Velcro be positioned at the first connector 1212, the second connector 1214, the third connector 1216, the fourth connector 1218, the fifth connector 1220, the sixth connector 1222, the seventh connector 1224, the eighth connector 1226, the ninth connector 1228, the tenth connector 1230, the eleventh connector 1232, and the twelfth connector 1234 to facilitate connection of the first puzzle piece 1200, the second puzzle piece 1202, the third puzzle piece 1204, the fourth puzzle piece 1206, the fifth puzzle piece 1208, and the sixth puzzle piece 1210, and/or to secure the first puzzle piece 1200, the second puzzle piece 1202, the third puzzle piece 1204, the fourth puzzle piece 1206, the fifth puzzle piece 1208, and the sixth puzzle piece 1210 together.

In certain embodiments, a shape of the first puzzle piece 1200, the second puzzle piece 1202, the third puzzle piece 1204, the fourth puzzle piece 1206, the fifth puzzle piece 1208, and the sixth puzzle piece 1210 may be different from a shape of puzzle pieces for other number puzzles so that first puzzle piece 1200, the second puzzle piece 1202, the third puzzle piece 1204, the fourth puzzle piece 1206, the fifth puzzle piece 1208, and the sixth puzzle piece 1210 will not fit together with puzzle pieces for other number puzzles. Moreover, it should be noted that for one number puzzle, pieces within the puzzle may have the same shape and may be interchangeable. For example, the fourth puzzle piece 1206, the fifth puzzle piece 1208, and the sixth puzzle piece 1210 may be the same shape, the same height, and/or the same width, and may be interchangeable. Accordingly, the fifth connector 1220, the seventh connector 1224, the ninth connector 1228, and the eleventh connector 1232 may have the same shape, and the sixth connector 1222, the eighth connector 1226, the tenth connector 1230, and the twelfth connector 1234 may have the same shape. Furthermore, if pieces within the puzzle do not have the same shape, the connectors on the puzzle pieces may be different so that pieces may not be improperly connected together.

FIG. 13 is an exploded perspective view of one embodiment of the sixth number puzzle 112 that forms the number six. Each of the first puzzle piece 1200, the second puzzle piece 1202, the third puzzle piece 1204, the fourth puzzle piece 1206, the fifth puzzle piece 1208, and the sixth puzzle piece 1210 has a numeral indicator 1300 that indicates that the first puzzle piece 1200, the second puzzle piece 1202, the third puzzle piece 1204, the fourth puzzle piece 1206, the fifth puzzle piece 1208, and the sixth puzzle piece 1210 belong to the sixth number puzzle 112. The numeral indicator 1300 may be any indication that the puzzle pieces are part of the sixth number puzzle 112, such as dots (e.g., 6 dots as illustrated), the numeral itself, or some other indication. In certain embodiments, the numeral indicator 1300 may be discernable visually (e.g., painted on, printed on, etc.) and/or tactilely (e.g., an indention, a protrusion, etc.). The number indicator 1300 may facilitate an individual knowing what number they are making by providing a hint about a shape and/or number of pieces for the puzzle that is being assembled.

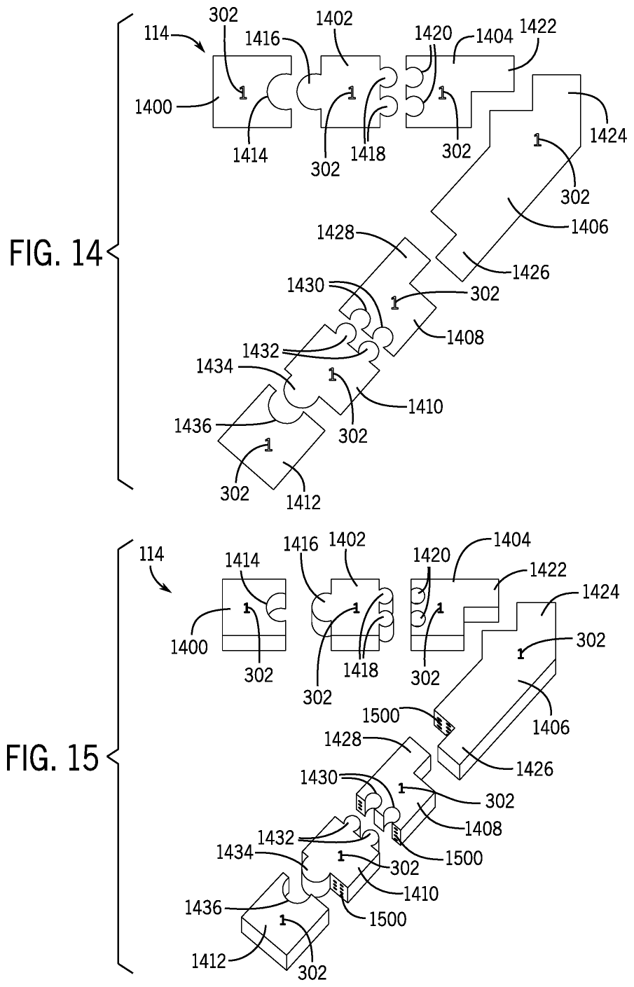

FIG. 14 is an exploded top view of one embodiment of the seventh number puzzle 114 that forms the number seven. The seventh number puzzle 114 has a first puzzle piece 1400, a second puzzle piece 1402, a third puzzle piece 1404, a fourth puzzle piece 1406, a fifth puzzle piece 1408, a sixth puzzle piece 1410, and a seventh puzzle piece 1412 so that the number of puzzle pieces (e.g., 7) equals the shape of the puzzle (e.g., shape of the number 7). The first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 each have the unitary indicator 302 that indicates the number 1. Thus, by adding the unitary indicators 302 of the first puzzle piece 1400 (e.g., 1), the second puzzle piece 1402 (e.g., 1), the third puzzle piece 1404 (e.g., 1), the fourth puzzle piece 1406 (e.g., 1), the fifth puzzle piece 1408 (e.g., 1), the sixth puzzle piece 1410 (e.g., 1), and the seventh puzzle piece 1412 (e.g., 1), they equal the number (e.g., 7) corresponding to the seventh number puzzle 114. This may facilitate an individual understanding the concept that a sum of the parts equals the whole number and/or may facilitate teaching fractions.

In some embodiments, a weight of each of the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 is substantially the same, and each of the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 matches a weight of individual pieces of other puzzles (e.g., the single puzzle piece 300). Accordingly, the weight of each puzzle piece among the set of number puzzles 100 is the same (e.g., approximately the same, within 1%, 5%, or 10% of one another). Moreover, a weight of a numeric number puzzle may be the weight of one piece (“P_{w}”) of the number puzzle times the numeral (e.g., 7). Therefore, if P_{w} is 100 grams, the weight of the seventh number puzzle 114 is 100 grams times 7=700 grams.

The first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 may be formed from any suitable material. For example, the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 may be formed from one or more of wood, plastic, metal, and so forth.

As illustrated, the first puzzle piece 1400 has a first connector 1414 that connects with a second connector 1416 of the second puzzle piece 1402 to connect the puzzle pieces together. Moreover, the second puzzle piece 1402 has a third connector 1418 that connects with a fourth connector 1420 of the third puzzle piece 1404. Furthermore, the third puzzle piece 1404 has a fifth connector 1422 that connects with a sixth connector 1424 of the fourth puzzle piece 1406. In addition, the fourth puzzle piece 1406 has a seventh connector 1426 that connects with an eighth connector 1428 of the fifth puzzle piece 1408. The fifth puzzle piece 1408 has a ninth connector 1430 that connects with a tenth connector 1432 of the sixth puzzle piece 1410. Moreover, the sixth puzzle piece 1410 has an eleventh connector 1434 that connects with a twelfth connector 1436 of the seventh puzzle piece 1412. In some embodiments, one or more magnets and/or Velcro be positioned at the first connector 1414, the second connector 1416, the third connector 1418, the fourth connector 1420, the fifth connector 1422, the sixth connector 1424, the seventh connector 1426, the eighth connector 1428, the ninth connector 1430, the tenth connector 1432, the eleventh connector 1434, and the twelfth connector 1436 to facilitate connection of the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412, and/or to secure the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 together.

In certain embodiments, a shape of the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 may be different from a shape of puzzle pieces for other number puzzles so that first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 will not fit together with puzzle pieces for other number puzzles. Moreover, it should be noted that for one number puzzle, pieces within the puzzle may have the same shape and may be interchangeable. For example, the first puzzle piece 1400 and the seventh puzzle piece 1412 may be the same shape, the same height, and/or the same width, and may be interchangeable, the second puzzle piece 1402 and the sixth puzzle piece 1410 may be the same shape, the same height, and/or the same width, and may be interchangeable, and the third puzzle piece 1404 and the fifth puzzle piece 1408 may be the same shape, the same height, and/or the same width, and may be interchangeable. Accordingly, connectors corresponding to interchangeable pieces may have the same shape. Furthermore, if pieces within the puzzle do not have the same shape, the connectors on the puzzle pieces may be different so that pieces may not be improperly connected together.

FIG. 15 is an exploded perspective view of one embodiment of the seventh number puzzle 114 that forms the number seven. Each of the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 has a numeral indicator 1500 that indicates that the first puzzle piece 1400, the second puzzle piece 1402, the third puzzle piece 1404, the fourth puzzle piece 1406, the fifth puzzle piece 1408, the sixth puzzle piece 1410, and the seventh puzzle piece 1412 belong to the seventh number puzzle 114. The numeral indicator 1500 may be any indication that the puzzle pieces are part of the seventh number puzzle 114, such as dots (e.g., 7 dots as illustrated), the numeral itself, or some other indication. In certain embodiments, the numeral indicator 1500 may be discernable visually (e.g., painted on, printed on, etc.) and/or tactilely (e.g., an indention, a protrusion, etc.). The number indicator 1500 may facilitate an individual knowing what number they are making by providing a hint about a shape and/or number of pieces for the puzzle that is being assembled.

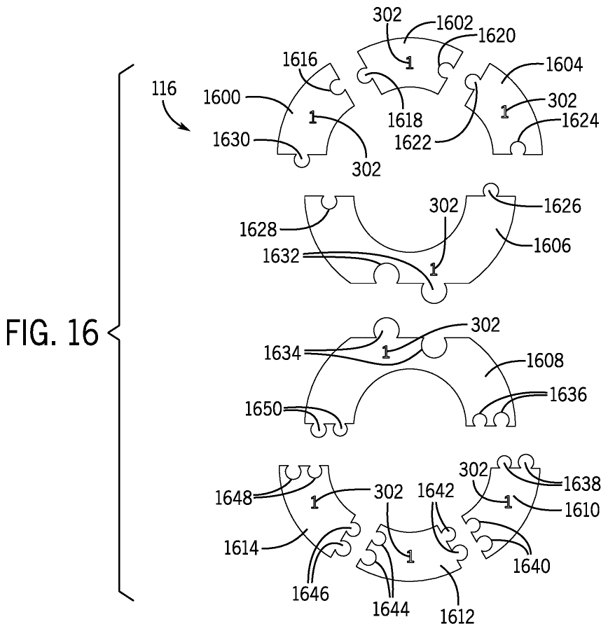

FIG. 16 is an exploded top view of one embodiment of the eighth number puzzle 116 that forms the number eight. The eighth number puzzle 116 has a first puzzle piece 1600, a second puzzle piece 1602, a third puzzle piece 1604, a fourth puzzle piece 1606, a fifth puzzle piece 1608, a sixth puzzle piece 1610, a seventh puzzle piece 1612, and an eighth puzzle piece 1614 so that the number of puzzle pieces (e.g., 8) equals the shape of the puzzle (e.g., shape of the number 8). The first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 each have the unitary indicator 302 that indicates the number 1. Thus, by adding the unitary indicators 302 of the first puzzle piece 1600 (e.g., 1), the second puzzle piece 1602 (e.g., 1), the third puzzle piece 1604 (e.g., 1), the fourth puzzle piece 1606 (e.g., 1), the fifth puzzle piece 1608 (e.g., 1), the sixth puzzle piece 1610 (e.g., 1), the seventh puzzle piece 1612 (e.g., 1), and the eighth puzzle piece 1614 (e.g., 1), they equal the number (e.g., 8) corresponding to the eighth number puzzle 116. This may facilitate an individual understanding the concept that a sum of the parts equals the whole number and/or may facilitate teaching fractions.

In some embodiments, a weight of each of the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 is substantially the same, and each of the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 matches a weight of individual pieces of other puzzles (e.g., the single puzzle piece 300). Accordingly, the weight of each puzzle piece among the set of number puzzles 100 is the same (e.g., approximately the same, within 1%, 5%, or 10% of one another). Moreover, a weight of a numeric number puzzle may be the weight of one piece (“P_{w}”) of the number puzzle times the numeral (e.g., 8). Therefore, if P_{w} is 100 grams, the weight of the eighth number puzzle 116 is 100 grams times 8=800 grams.

The first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 may be formed from any suitable material. For example, the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 may be formed from one or more of wood, plastic, metal, and so forth.

As illustrated, the first puzzle piece 1600 has a first connector 1616 that connects with a second connector 1618 of the second puzzle piece 1602 to connect the puzzle pieces together. Moreover, the second puzzle piece 1602 has a third connector 1620 that connects with a fourth connector 1622 of the third puzzle piece 1604. Furthermore, the third puzzle piece 1604 has a fifth connector 1624 that connects with a sixth connector 1626 of the fourth puzzle piece 1606. The fourth puzzle piece 1606 has a seventh connector 1628 that connects with an eighth connector 1630 of the first puzzle piece 1600. In addition, the fourth puzzle piece 1606 has a ninth connector 1632 that connects with a tenth connector 1634 of the fifth puzzle piece 1608. The fifth puzzle piece 1608 has an eleventh connector 1636 that connects with a twelfth connector 1638 of the sixth puzzle piece 1610. Moreover, the sixth puzzle piece 1610 has a thirteenth connector 1640 that connects with a fourteenth connector 1642 of the seventh puzzle piece 1612. Furthermore, the seventh puzzle piece 1612 has a fifteenth connector 1644 that connects with a sixteenth connector 1646 of the eighth puzzle piece 1614. The eighth puzzle piece 1614 has a seventeenth connector 1648 that connects with an eighteenth connector 1650 of the fifth puzzle piece 1608. In some embodiments, one or more magnets and/or Velcro be positioned at the first connector 1616, the second connector 1618, the third connector 1620, the fourth connector 1622, the fifth connector 1624, the sixth connector 1626, the seventh connector 1628, the eighth connector 1630, the ninth connector 1632, the tenth connector 1634, the eleventh connector 1636, the twelfth connector 1638, the thirteenth connector 1640, the fourteenth connector 1642, the fifteenth connector 1644, the sixteenth connector 1646, the seventeenth connector 1648, and the eighteenth connector 1650 to facilitate connection of the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614, and/or to secure the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 together.

In certain embodiments, a shape of the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 may be different from a shape of puzzle pieces for other number puzzles so that first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 will not fit together with puzzle pieces for other number puzzles. Moreover, it should be noted that for one number puzzle, pieces within the puzzle may have the same shape and may be interchangeable. For example, the first puzzle piece 1600, the second puzzle piece 1602, the third puzzle piece 1604, the sixth puzzle piece 1610, the seventh puzzle piece 1612, and the eighth puzzle piece 1614 may be the same shape, the same height, and/or the same width, and may be interchangeable. Accordingly, the first connector 1616, the third connector 1620, the fifth connector 1624, the seventh connector 1628, the twelfth connector 1638, the fourteenth connector 1642, the sixteenth connector 1646, and the eighteenth connector 1650 may have the same shape, and the second connector 1618, the fourth connector 1622, the sixth connector 1626, the eighth connector 1630, the eleventh connector 1636, the thirteenth connector 1640, the fifteenth connector 1644, and the seventeenth connector 1648 may have the same shape. In some embodiments, the fourth puzzle piece 1606 and the fifth puzzle piece 1608 may be the same shape, the same height, and/or the same width, and may be interchangeable. Furthermore, if pieces within the puzzle do not have the same shape, the connectors on the puzzle pieces may be different so that pieces may not be improperly connected together.

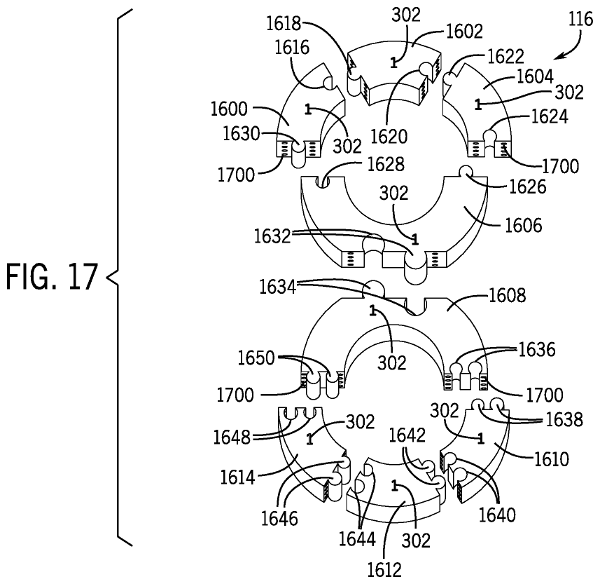

FIG. 17 is an exploded perspective view of one embodiment of the eighth number puzzle 116 that forms the number eight. Each of the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 has a numeral indicator 1700 that indicates that the first puzzle piece 1600, the second puzzle piece 1602, the third puzzle piece 1604, the fourth puzzle piece 1606, the fifth puzzle piece 1608, the sixth puzzle piece 1610, the seventh puzzle piece 1612, and the eighth puzzle piece 1614 belong to the eighth number puzzle 116. The numeral indicator 1700 may be any indication that the puzzle pieces are part of the eighth number puzzle 116, such as dots (e.g., 8 dots as illustrated), the numeral itself, or some other indication. In certain embodiments, the numeral indicator 1700 may be discernable visually (e.g., painted on, printed on, etc.) and/or tactilely (e.g., an indention, a protrusion, etc.). The number indicator 1700 may facilitate an individual knowing what number they are making by providing a hint about a shape and/or number of pieces for the puzzle that is being assembled.

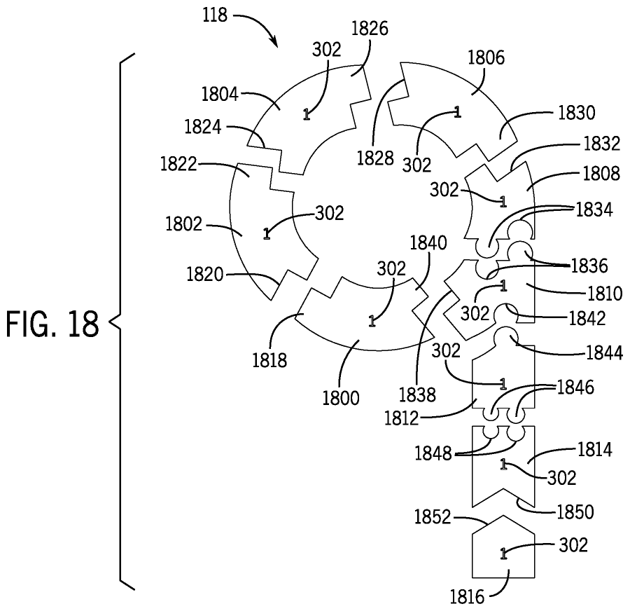

FIG. 18 is an exploded top view of one embodiment of the ninth number puzzle 118 that forms the number nine. The ninth number puzzle 118 has a first puzzle piece 1800, a second puzzle piece 1802, a third puzzle piece 1804, a fourth puzzle piece 1806, a fifth puzzle piece 1808, a sixth puzzle piece 1810, a seventh puzzle piece 1812, an eighth puzzle piece 1814, and a ninth puzzle piece 1816 so that the number of puzzle pieces (e.g., 9) equals the shape of the puzzle (e.g., shape of the number 9). The first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 each have the unitary indicator 302 that indicates the number 1. Thus, by adding the unitary indicators 302 of the first puzzle piece 1800 (e.g., 1), the second puzzle piece 1802 (e.g., 1), the third puzzle piece 1804 (e.g., 1), the fourth puzzle piece 1806 (e.g., 1), the fifth puzzle piece 1808 (e.g., 1), the sixth puzzle piece 1810 (e.g., 1), the seventh puzzle piece 1812 (e.g., 1), the eighth puzzle piece 1814 (e.g., 1), and the ninth puzzle piece 1816 (e.g., 1), they equal the number (e.g., 9) corresponding to the ninth number puzzle 118. This may facilitate an individual understanding the concept that a sum of the parts equals the whole number and/or may facilitate teaching fractions.

In some embodiments, a weight of each of the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 is substantially the same, and each of the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 matches a weight of individual pieces of other puzzles (e.g., the single puzzle piece 300). Accordingly, the weight of each puzzle piece among the set of number puzzles 100 is the same (e.g., approximately the same, within 1%, 5%, or 10% of one another). Moreover, a weight of a numeric number puzzle may be the weight of one piece (“P_{w}”) of the number puzzle times the numeral (e.g., 9). Therefore, if P_{w} is 100 grams, the weight of the ninth number puzzle 118 is 100 grams times 9=900 grams.

The first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 may be formed from any suitable material. For example, the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 may be formed from one or more of wood, plastic, metal, and so forth.

As illustrated, the first puzzle piece 1800 has a first connector 1818 that connects with a second connector 1820 of the second puzzle piece 1802 to connect the puzzle pieces together. Moreover, the second puzzle piece 1802 has a third connector 1822 that connects with a fourth connector 1824 of the third puzzle piece 1804. Furthermore, the third puzzle piece 1804 has a fifth connector 1826 that connects with a sixth connector 1828 of the fourth puzzle piece 1806. The fourth puzzle piece 1806 has a seventh connector 1830 that connects with an eighth connector 1832 of the fifth puzzle piece 1808. In addition, the fifth puzzle piece 1808 has a ninth connector 1834 that connects with a tenth connector 1836 of the sixth puzzle piece 1810. The sixth puzzle piece 1810 has an eleventh connector 1838 that connects with a twelfth connector 1840 of the first puzzle piece 1800. Moreover, the sixth puzzle piece 1810 has a thirteenth connector 1842 that connects with a fourteenth connector 1844 of the seventh puzzle piece 1812. Furthermore, the seventh puzzle piece 1812 has a fifteenth connector 1846 that connects with a sixteenth connector 1848 of the eighth puzzle piece 1814. The eighth puzzle piece 1814 has a seventeenth connector 1850 that connects with an eighteenth connector 1852 of the ninth puzzle piece 1816. In some embodiments, one or more magnets and/or Velcro be positioned at the first connector 1818, the second connector 1820, the third connector 1822, the fourth connector 1824, the fifth connector 1826, the sixth connector 1828, the seventh connector 1830, the eighth connector 1832, the ninth connector 1834, the tenth connector 1836, the eleventh connector 1838, the twelfth connector 1840, the thirteenth connector 1842, the fourteenth connector 1844, the fifteenth connector 1846, the sixteenth connector 1848, the seventeenth connector 1850, and the eighteenth connector 1852 to facilitate connection of the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816, and/or to secure the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 together.

In certain embodiments, a shape of the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 may be different from a shape of puzzle pieces for other number puzzles so that first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 will not fit together with puzzle pieces for other number puzzles. Moreover, it should be noted that for one number puzzle, pieces within the puzzle may have the same shape and may be interchangeable. For example, the first puzzle piece 1800, the second puzzle piece 1802, the third puzzle piece 1804, and the fourth puzzle piece 1806 may be the same shape, the same height, and/or the same width, and may be interchangeable. Accordingly, the first connector 1818, the third connector 1822, the fifth connector 1826, the seventh connector 1830, and the eleventh connector 1838 may have the same shape, and the second connector 1820, the fourth connector 1824, the sixth connector 1828, the eighth connector 1832, and the twelfth connector 1840 may have the same shape. Furthermore, if pieces within the puzzle do not have the same shape, the connectors on the puzzle pieces may be different so that pieces may not be improperly connected together.

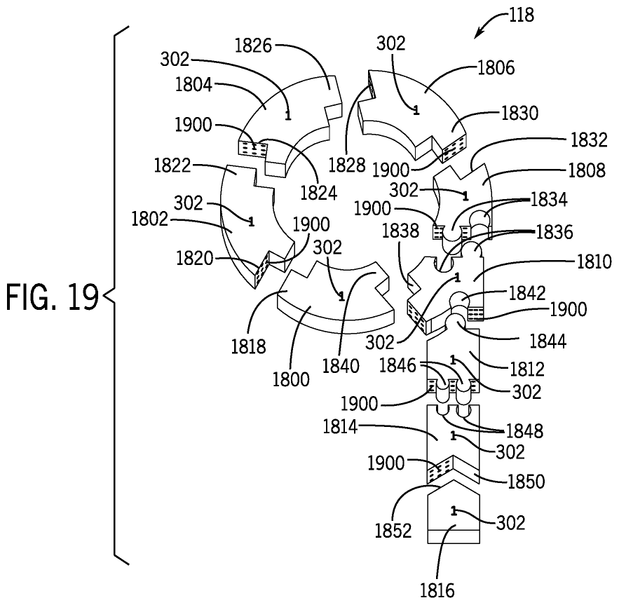

FIG. 19 is an exploded perspective view of one embodiment of the ninth number puzzle 118 that forms the number nine. Each of the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 has a numeral indicator 1900 that indicates that the first puzzle piece 1800, the second puzzle piece 1802, the third puzzle piece 1804, the fourth puzzle piece 1806, the fifth puzzle piece 1808, the sixth puzzle piece 1810, the seventh puzzle piece 1812, the eighth puzzle piece 1814, and the ninth puzzle piece 1816 belong to the ninth number puzzle 118. The numeral indicator 1900 may be any indication that the puzzle pieces are part of the ninth number puzzle 118, such as dots (e.g., 9 dots as illustrated), the numeral itself, or some other indication. In certain embodiments, the numeral indicator 1900 may be discernable visually (e.g., painted on, printed on, etc.) and/or tactilely (e.g., an indention, a protrusion, etc.). The number indicator 1900 may facilitate an individual knowing what number they are making by providing a hint about a shape and/or number of pieces for the puzzle that is being assembled.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An apparatus comprising:
a puzzle comprising a plurality of pieces that form a numeral, wherein the puzzle comprises:
a shape that matches the numeral; and
a number of the plurality of pieces equal to the numeral.

2. The apparatus of claim 1, wherein a weight of each piece of the plurality of pieces is substantially the same.

3. The apparatus of claim 1, wherein a weight of the puzzle comprises a weight of one piece of the plurality of pieces times the numeral.

4. The apparatus of claim 1, wherein each piece of the plurality of pieces comprises an indicator corresponding to the numeral.

5. The apparatus of claim 1, wherein each piece of the plurality of pieces comprises an indicator indicating the numeral.

6. The apparatus of claim 1, wherein each piece of the plurality of pieces comprises an indicator indicating a number one.

7. The apparatus of claim 1, wherein a height of the puzzle is directly proportional to the numeral.

8. The apparatus of claim 7, wherein the height of the puzzle is determined based on the following formula: the height=x*(the numeral−1)+y.

9. The apparatus of claim 1, wherein at least two pieces of the plurality of pieces have the same shape.

10. The apparatus of claim 1, wherein pieces of the plurality of pieces that do not have the same shape cannot be improperly connected together.

11. An apparatus comprising:
a first puzzle comprising a first plurality of pieces that form a first numeral, wherein the first puzzle comprises:
a first shape that matches the first numeral; and
the first plurality of pieces equal to the first numeral; and
a second puzzle comprising a second plurality of pieces that form a second numeral, wherein the second puzzle comprises:
a second shape that matches the second numeral; and
the second plurality of pieces equal to the second numeral, wherein the first numeral and the second numeral are different.

12. The apparatus of claim 11, wherein a first weight of each piece of the first plurality of pieces is substantially the same as a second weight of each piece of the second plurality of pieces.

13. The apparatus of claim 11, wherein a first weight of the first puzzle comprises a weight of one piece of the first plurality of pieces times the first numeral, and a second weight of the second puzzle comprises the weight times the second numeral.

14. The apparatus of claim 11, wherein a first height of the first puzzle is directly proportional to the first numeral, and a second height of the second puzzle is directly proportional to the second numeral.

15. The apparatus of claim 14, wherein the first height of the first puzzle is determined based on the following formula: the first height=x*(the first numeral−1)+y, and the second height of the second puzzle is determined based on the following formula: the second height=x*(the second numeral−1)+y.

16. The apparatus of claim 11, wherein each piece of the first plurality of pieces has a different shape from each piece of the second plurality of pieces.

17. An apparatus comprising:
a first puzzle comprising one piece that forms the number one in a first shape that matches the number one;
a second puzzle comprising two pieces that form the number two in a second shape that matches the number two;
a third puzzle comprising three pieces that form the number three in a third shape that matches the number three;
a fourth puzzle comprising four pieces that form the number four in a fourth shape that matches the number four;
a fifth puzzle comprising five pieces that form the number five in a fifth shape that matches the number five;
a sixth puzzle comprising six pieces that form the number six in a sixth shape that matches the number six;
a seventh puzzle comprising seven pieces that form the number seven in a seventh shape that matches the number seven;
an eighth puzzle comprising eight pieces that form the number eight in an eighth shape that matches the number eight; and
a ninth puzzle comprising nine pieces that form the number nine in a ninth shape that matches the number nine.

18. The apparatus of claim 17, wherein a first weight of the first puzzle is substantially the same as a second weight of each piece of the second puzzle, a third weight of each piece of the third puzzle, a fourth weight of each piece of the fourth puzzle, a fifth weight of each piece of the fifth puzzle, a sixth weight of each piece of the sixth puzzle, a seventh weight of each piece of the seventh puzzle, an eight weight of each piece of the eight puzzle, and a ninth weight of each piece of the ninth puzzle.

19. The apparatus of claim 17, wherein each piece of the first puzzle comprises a first indicator corresponding to the number one, each piece of the second puzzle comprises a second indicator corresponding to the number two, each piece of the third puzzle comprises a third indicator corresponding to the number three, each piece of the fourth puzzle comprises a fourth indicator corresponding to the number four, each piece of the fifth puzzle comprises a fifth indicator corresponding to the number five, each piece of the sixth puzzle comprises a sixth indicator corresponding to the number six, each piece of the seventh puzzle comprises a seventh indicator corresponding to the number seven, each piece of the eighth puzzle comprises an eighth indicator corresponding to the number eight, and each piece of the ninth puzzle comprises a ninth indicator corresponding to the number nine.

20. The apparatus of claim 17, wherein a first height of the first puzzle is determined based on the following formula: the first height=x*(the number one−1)+y, a second height of the second puzzle is determined based on the following formula: the second height=x*(the number two−1)+y, a third height of the third puzzle is determined based on the following formula: the third height=x*(the number three−1)+y, a fourth height of the fourth puzzle is determined based on the following formula: the fourth height=x*(the number four−1)+y, a fifth height of the fifth puzzle is determined based on the following formula: the fifth height=x*(the number five−1)+y, a sixth height of the sixth puzzle is determined based on the following formula: the sixth height=x*(the number six−1)+y, a seventh height of the seventh puzzle is determined based on the following formula: the seventh height=x*(the number seven−1)+y, an eighth height of the eighth puzzle is determined based on the following formula: the eighth height=x*(the number eight−1)+y, and a ninth height of the ninth puzzle is determined based on the following formula: the ninth height=x*(the number nine−1)+y.
